(19) United States
(12) Patent Application Publication
(10) Pub. No.: US 2025/0212218 A1
(43) Pub. Date: Jun. 26, 2025

(54) METHODS FOR REDUCING PADDING IN UPLINK TRANSMISSIONS IN MOBILE COMMUNICATIONS

(71) Applicant: MediaTek Singapore Pte. Ltd., Singapore (SG)

(72) Inventors: Mehmet KUNT, Cambridge (GB); Pradeep JOSE, Cambridge (GB); Abdellatif SALAH, Cambridge (GB)

(21) Appl. No.: 18/844,906

(22) PCT Filed: Apr. 28, 2023
(86) PCT No.: PCT/CN2023/091419

§ 371 Date: Sep. 6, 2024

Related U.S. Application Data
(60) Provisional application No. 63/344,649, filed on May 23, 2022.

(51) Int. Cl. H04W 72/21; H04W 72/115

(52) U.S. Cl. CPC H04W 72/21; H04W 72/115

(57) ABSTRACT

Techniques and solutions pertaining to reducing padding in uplink (UL) transmissions in mobile communications are described. An apparatus (e.g., user equipment (UE)) receives, from a network, a configuration of multiple overlapping configured grants (CGs) or multiple overlapping dynamic grants (DGs). The apparatus selects a CG or DG from the multiple overlapping CGs or DGs to perform transmission in the selected CG or DG. The apparatus then indicates the selected CG or DG to the network.

### CROSS REFERENCE TO RELATED PATENT APPLICATION(S)

The present disclosure is part of a non-provisional application claiming the priority benefit of U.S. Patent Application No. 63/344,649, filed 23 May 2022, the content of which herein being incorporated by reference in its entirety.

### TECHNICAL FIELD

The present disclosure is generally related to mobile communications and, more particularly, to techniques for reducing padding in uplink (UL) transmissions in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), applications such as extended reality (XR), augmented reality (AR) and cloud gaming tend to have a variation in the size of media frames generated by the media coders/decoders (codecs). In case that configured grants (CGs) are used for transmitting the media frames in UL, the proportion of padding bits with respect to a medium access control (MAC) service data unit (SDU) within a transport block (TB) can be rather large. For example, a network could allocate CG resources for transmitting I-frames while the same resources could be used for P-frames. Even when dynamic grants (DGs) are used, the size of padding bits can also be large. Undesirably, this tends to result in higher power consumption (e.g., for physical uplink shared channel (PUSCH) transmissions) and waste of UL resources. Therefore, there is a need for a solution of reducing padding in uplink (UL) transmissions in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving reducing padding in UL transmissions in mobile communications. It is believed that, under the various proposed schemes, aforementioned issues may be avoided, reduced or otherwise alleviated.

In one aspect, a method may involve user equipment (UE) receiving, from a network, a configuration of multiple overlapping CGs or multiple overlapping DGs. The method may also involve the UE selecting a CG or DG from the multiple overlapping CGs or DGs to perform transmission in the selected CG or DG. The method may further involve the UE indicating the selected CG or DG to the network.

In another aspect, an apparatus implementable in a UE may include a transceiver configured to communicate wirelessly and a processor coupled to the transceiver. The processor may receive, from a network, a configuration of multiple overlapping CGs or multiple overlapping DGs. The processor may also select a CG or DG from the multiple overlapping CGs or DGs to perform transmission in the selected CG or DG. The processor may further indicate the selected CG or DG to the network.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reducing padding in UL transmissions in mobile communications. According to the present disclosure, a number of possible solutions may be implemented separately or jointly. That is, although these possible solutions may be described below separately, two or more of these possible solutions may be implemented in one combination or another.

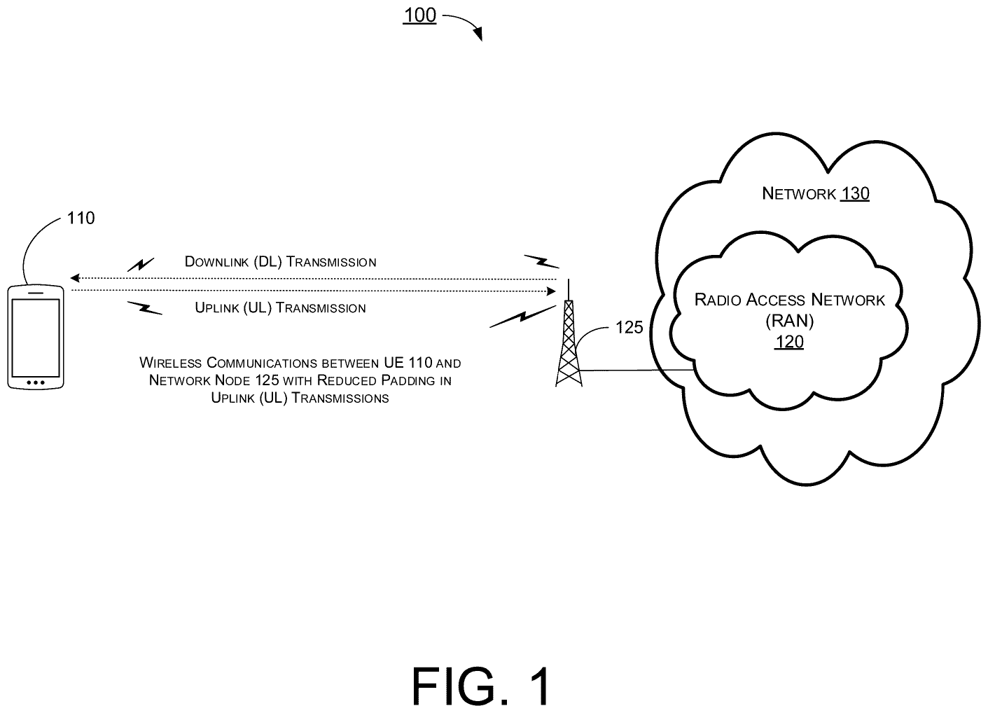

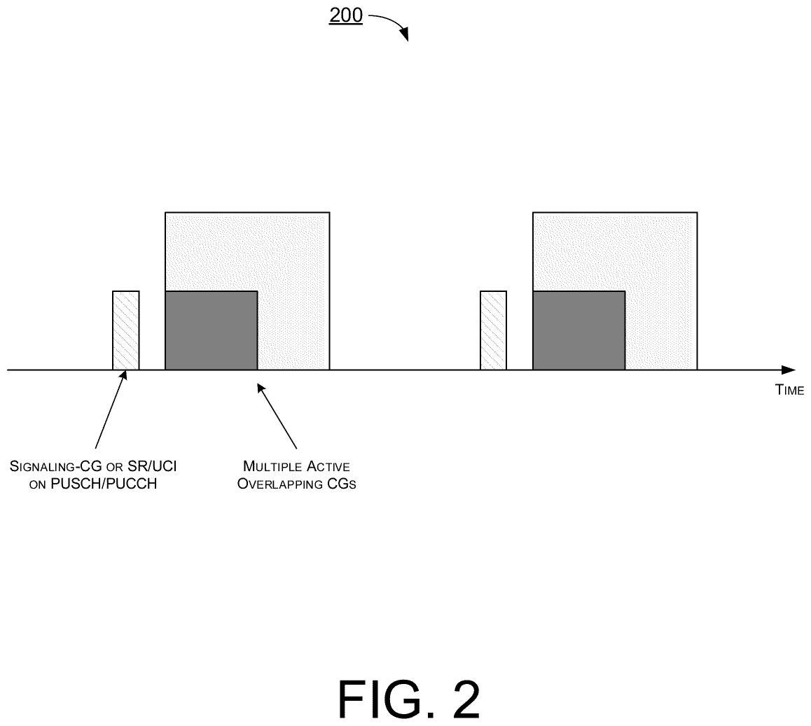

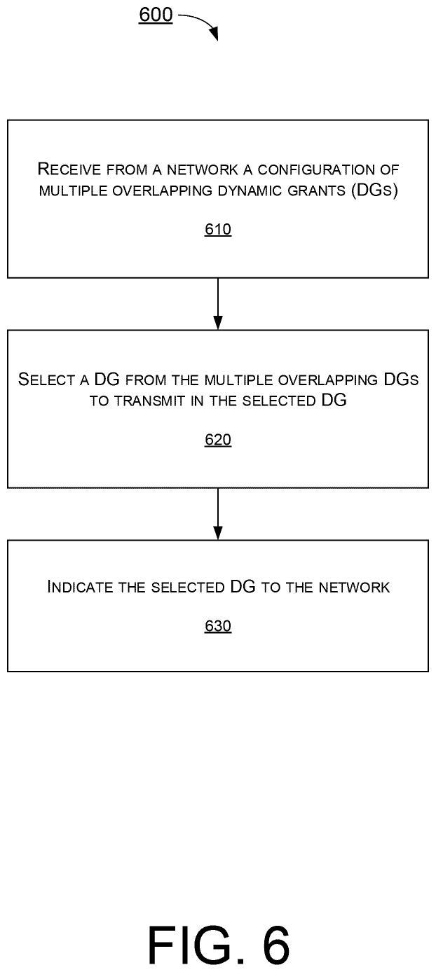

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to reducing padding in UL transmissions in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a proposed scheme in accordance with the present disclosure, multiple active CGs (herein interchangeably referred to as “data-CGs”) may be defined for a UE (e.g., UE 110). Before each occurrence of an overlapping CG occasion, a small CG (or CGs) (herein interchangeably referred to as “signaling-CG”) may be defined. The signaling-CG(s) may be used by UE 110 to indicate to a network (e.g., network 130) the selected CG from subsequent multiple overlapping data-CG occasion(s), using a special UL medium access control (MAC) control element (CE) (herein interchangeably referred to as “Signaling MAC CE”). The Signaling MAC CE may be transmitted on the signaling-CG in case that the selected data-CG changes from a previous transmission; otherwise, the signaling-CG may be skipped. Under the proposed scheme, there may be some MAC CE restrictions for CGs that may be introduced so that Signaling MAC CE may only be transmitted on a specific signaling-CG. Under the proposed scheme, a priority of the Signaling MAC CE may be higher than that of data (and a subset of other MAC CEs). Alternatively, the signaling-CG may only be used to transmit the Signaling MAC CE. Moreover, in case there is no XR/AR data to transmit, the data-CGs may be skipped.

Under a proposed scheme in accordance with the present disclosure, instead of the signaling-CG, selection of data-CG may be indicated by a UE (e.g., UE 110) via uplink control information (UCI) transmitted on a physical uplink control channel (PUCCH). Alternatively, or additionally, selection of data-CG may be indicated by the UE via a scheduling request (SR), which may be, for example, a special SR carrying more than 1 bit. For instance, a toggle bit in the UCI or SR may be used to indicate a change for the data-CG with respect to the selected data-CG for a previous transmission.

Under a proposed scheme in accordance with the present disclosure, in case that a Type-2 CG is used for data-CG, a special DCI may be designed to activate more than one Type-2 CG, which may be used, for example, to activate multiple overlapping Type-2 CGs. Alternatively, unused bits in existing DCIs may be used for this purpose.

Under a proposed scheme in accordance with the present disclosure, a similar mechanism may be used for DGs by indicating multiple DGs (pre-DG and data-DGs) in DCI, using DG skipping. Moreover, some special logical channel (LCH) restrictions (e.g., for DGs) may be introduced so that a special MAC CE is transmitted (only) on the pre-DG.

As an illustrative example without limiting the scope of the present disclosure, an example procedure of reducing padding in UL transmissions may involve execution of one, some or all of the operations described below. In the procedure, multiple overlapping data-CGs and a signaling-CG that precedes the data-CGs in time domain may be defined. An initial CG index from data-CGs may be selected by a radio resource control (RRC) configuration or DCI (e.g., for CG activation). In case that the UL data fits a different data-CG than the one previously selected, a UE (e.g., UE 110) may transmit a Signaling MAC CE on the signaling-CG. A network (e.g., network 130) may decode the data-CGs based on what is indicated in the Signaling MAC CE. In case that the same data-CG index is used as the previous one, the signaling-CG may be skipped. In such cases, the network may decode the data-CGs using the previous data-CG index selection. In case that there is no data to transmit, both signaling-CG and data-CGs may be skipped. In case that the network does not detect signaling-CG but detects data-CG, the network may decode the data-CG according to previous selection of data-CG index.

Moreover, in case that the network detects but cannot decode signaling-CG, the network may perform one or more operations. For instance, the network may send a retransmission grant (e.g., addressed to a configured scheduling radio network temporary identifier (CS-RNTI)) with a maximum size to retransmit the data (e.g., maximum size for data-CG). It is noteworthy that this approach may result in power/resource cost, also complexity, and a corresponding transport block (TB) may need to be re-encoded to fit the maximum UL grant. Alternatively, or additionally, the network may send a retransmission grant for the signaling-CG and determine the size, then send a retransmission grant for data-CG (e.g., latency cost). Alternatively, or additionally, the network may send a retransmission grant with multiple overlapping DGs (e.g., with signaling-DG and data-CGs).

In case that the UE transmits the signaling-CG but the network does not detect it, decoding of the data-CG may fail in the network. In such cases, the network may perform certain operations. For instance, the network may send a retransmission grant (e.g., addressed to CS-RNTI) with a maximum size to retransmit the data (e.g., maximum size for data-CG). It is noteworthy that this approach may result in power/resource cost, also complexity, and a corresponding TB may need to be re-encoded to fit the maximum UL grant. Alternatively, or additionally, the network may send a retransmission grant with multiple overlapping DGs (e.g., with signaling-DG and data-CGs).

In case that the network decodes the signaling-CG but cannot decode the data-CG or does not detect the data-CG, the network may send a retransmission grant for the data-CG with the size indicated in the signaling-CG.

Under a proposed scheme in accordance with the present disclosure, multiple CGs may be defined explicitly. For instance, multiple CGs may be defined using separate CG configurations and indices. Alternatively, the resources for data-CGs may be determined by a rule (e.g., by defining a base CG, increment, and a limit). For instance, CG₀ and a CGᵢ (=F(CG₀)) may be defined where the function F may be defined in the 3GPP specification. It is noteworthy that this proposed scheme may be applicable for any layer 1 (L1) parameter (e.g., modulation and coding scheme (MCS)).

Under a proposed scheme in accordance with the present disclosure, a special UCI format or demodulation reference signal (DMRS) may be used to indicate the selected CG and/or DG. The UCI or DMRS may be transmitted with data. Moreover, the UCI may be transmitted by puncturing with the data-CG/DG.

In view of the above, under one or more of the schemes proposed herein, overlapping CG/DGs may be defined, and one of the overlapping CG/DGs may be selected by UE 110 for transmission and indicated to network 130. Moreover, signaling-CG/DG(s) preceding the overlapping CG/DGs in time domain may be defined. In such cases, the selected CG/DG may be indicated by UE 110 by transmitting a MAC CE in the signaling-CG/DG(s). Additionally, SR occasion(s) or PUCCH resources for transmitting UCI preceding the overlapping CG/DGs in time domain may be defined. In such cases, the selected CG/DG may be indicated by UE 110 by transmitting a SR in the SR occasion(s) or UCI. Furthermore, the selected CG/DG may be indicated by UE 110 by using a special DMRS or UCI transmitted with the selected CG/DG.

FIG. 2 illustrates an example scenario 200 under a proposed scheme in accordance with the present disclosure. Under the proposed scheme, multiple overlapping CGs may be configured for a given UE (e.g., UE 110). Moreover, the UE may select one of the overlapping CGs for transmission and indicate the selection to a network (e.g., network 130). Referring to FIG. 2, UE 110 may receive from network 130 (e.g., via network node 125) a configuration of multiple overlapping CGs. After selecting one of the multiple overlapping CGs for transmission, UE 110 may indicate its selection to network 130 by a signaling-CG or UCI or SR that is transmitted in a PUSCH and/or PUCCH.

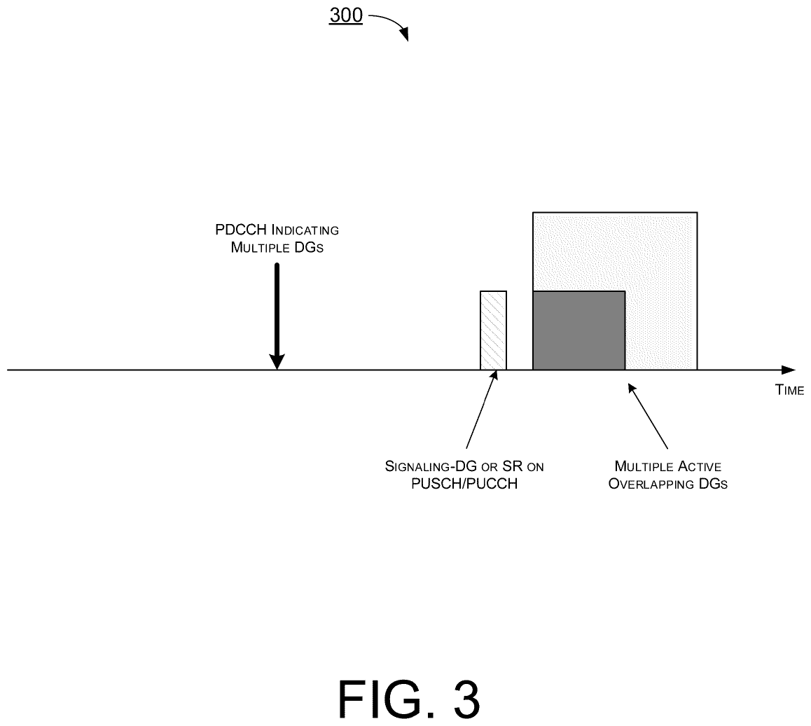

FIG. 3 illustrates an example scenario 300 under a proposed scheme in accordance with the present disclosure. Under the proposed scheme, multiple overlapping DGs may be indicated to a UE (e.g., UE 110) by the network (e.g., in downlink control information (DCI)). For instance, the DCI indicating overlapping DGs may be transmitted by the network in a physical downlink control channel (PDCCH). Accordingly, the UE may select one of the overlapping DGs for transmission and indicate the selection to the network. Referring to FIG. 3, UE 110 may receive from network 130 (e.g., via network node 125) a configuration of multiple overlapping DGs. For instance, UE 110 may receive an indication of such configuration in a PDCCH. After selecting one of the multiple overlapping DGs for transmission, UE 110 may indicate its selection to network 130 by a signaling-DG or SR that is transmitted in a PUSCH and/or PUCCH.

### Illustrative Implementations

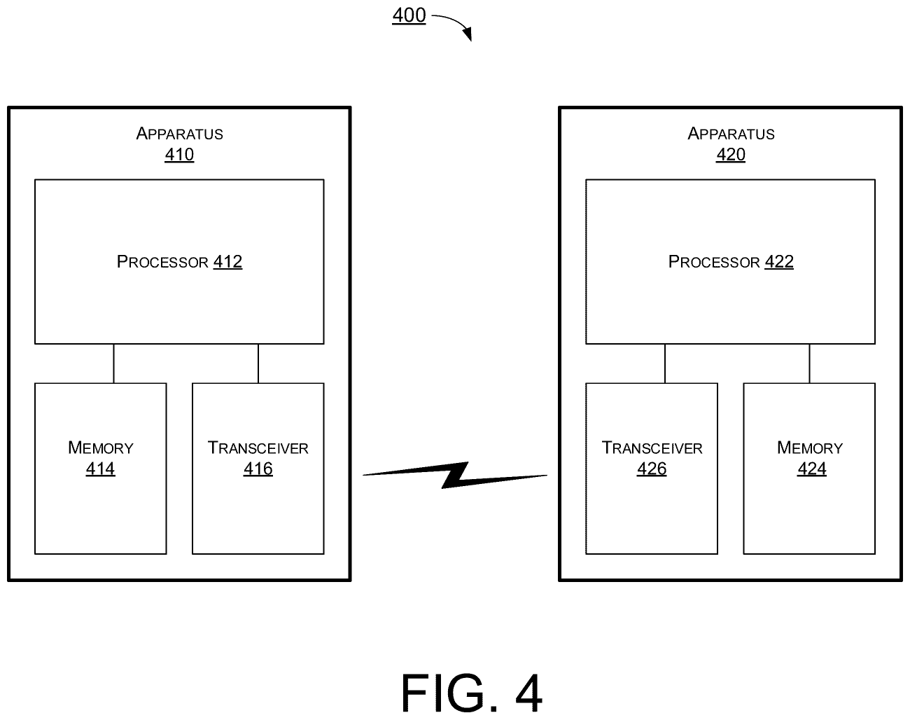

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to reducing padding in UL transmissions in mobile communications, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to reducing padding in UL transmissions in mobile communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE (e.g., UE 110), and apparatus 420, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to reducing padding in UL transmissions in mobile communications, processor 412 of apparatus 410, implemented in or as a UE (e.g., UE 110) may receive, via transceiver 416, from a network a configuration of multiple overlapping CGs. Additionally, processor 412 may select a CG from the multiple overlapping CGs to perform transmission in the selected CG. Moreover, processor 412 may indicate, via transceiver 416, the selected CG to the network.

In some implementations, the multiple overlapping CGs may overlap in a time domain.

In some implementations, in indicating the selected CG, processor 412 may transmit to the network a signaling CG to indicate the selected CG. For instance, processor 412 may transmit a MAC CE in the signaling CG to indicate the selected CG.

Alternatively, or additionally, in indicating the selected CG, processor 412 may transmit to the network a SR in a SR occasion or using a PUCCH resource to indicate the selected CG.

Alternatively, or additionally, in indicating the selected CG, processor 412 may transmit to the network an UCI signal in a PUCCH resource to indicate the selected CG.

Alternatively, or additionally, in indicating the selected CG, processor 412 may transmit to the network a DMRS or an UCI signal with the selected CG to indicate the selected CG.

Under other proposed schemes in accordance with the present disclosure pertaining to reducing padding in UL transmissions in mobile communications, processor 412 of apparatus 410, implemented in or as a UE (e.g., UE 110) may receive, via transceiver 416, from a network a configuration of multiple overlapping DGs. Moreover, processor 412 may select a DG from the multiple overlapping DGs to perform transmission in the selected DG. Furthermore, processor 412 may indicate, via transceiver 416, the selected DG to the network.

In some implementations, the multiple overlapping DGs may overlap in a time domain.

In some implementations, in indicating the selected DG, processor 412 may transmit to the network a signaling DG to indicate the selected DG. For instance, processor 412 may transmit a MAC CE in the signaling DG to indicate the selected DG.

Alternatively, or additionally, in indicating the selected DG, processor 412 may transmit to the network a SR in a SR occasion or using a PUCCH resource to indicate the selected DG.

Alternatively, or additionally, in indicating the selected DG, processor 412 may transmit to the network an UCI signal in a PUCCH resource to indicate the selected DG.

Alternatively, or additionally, in indicating the selected DG, processor 412 may transmit to the network a DMRS or an UCI signal with the selected DG to indicate the selected DG.

### Illustrative Processes

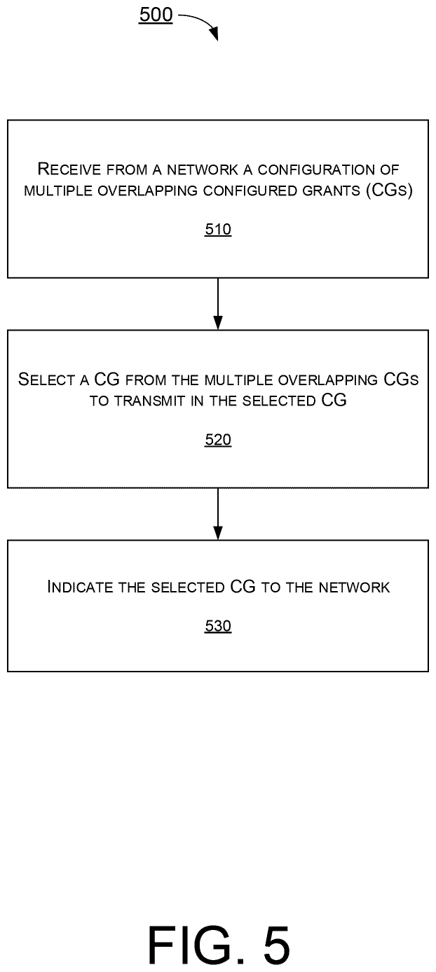

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to reducing padding in UL transmissions in mobile communications. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., network node 125 or another network node implementing one or more network-side functionalities described above) of an application server side network (e.g., network 130). Process 500 may begin at block 510.

At 510, process 500 may involve processor 412 of apparatus 410, implemented in or as a UE (e.g., UE 110) receiving, via transceiver 416, from a network a configuration of multiple overlapping CGs. Process 500 may proceed from 510 to 520.

At 520, process 500 may involve processor 412 selecting a CG from the multiple overlapping CGs to perform transmission in the selected CG. Process 500 may proceed from 520 to 530.

At 530, process 500 may involve processor 412 indicating, via transceiver 416, the selected CG to the network.

In some implementations, the multiple overlapping CGs may overlap in a time domain.

In some implementations, in indicating the selected CG, process 500 may involve processor 412 transmitting to the network a signaling CG to indicate the selected CG. For instance, process 500 may involve processor 412 transmitting a MAC CE in the signaling CG to indicate the selected CG.

Alternatively, or additionally, in indicating the selected CG, process 500 may involve processor 412 transmitting to the network a SR in a SR occasion or using a PUCCH resource to indicate the selected CG.

Alternatively, or additionally, in indicating the selected CG, process 500 may involve processor 412 transmitting to the network an UCI signal in a PUCCH resource to indicate the selected CG.

Alternatively, or additionally, in indicating the selected CG, process 500 may involve processor 412 transmitting to the network a DMRS or an UCI signal with the selected CG to indicate the selected CG.

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to those described above. More specifically, process 600 may represent an aspect of the proposed concepts and schemes pertaining to reducing padding in UL transmissions in mobile communications. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 410 and apparatus 420 as well as any variations thereof. Solely for illustrative purposes and without limiting the scope, process 600 is described below in the context of apparatus 410 as a UE (e.g., UE 110) and apparatus 420 as a communication entity such as a network node or base station (e.g., network node 125 or another network node implementing one or more network-side functionalities described above) of an application server side network (e.g., network 130). Process 600 may begin at block 610.

At 610, process 600 may involve processor 412 of apparatus 410, implemented in or as a UE (e.g., UE 110) receiving, via transceiver 416, from a network a configuration of multiple overlapping DGs. Process 600 may proceed from 610 to 620.

At 620, process 600 may involve processor 412 selecting a DG from the multiple overlapping DGs to perform transmission in the selected DG. Process 600 may proceed from 620 to 630.

At 630, process 600 may involve processor 412 indicating, via transceiver 416, the selected DG to the network.

In some implementations, the multiple overlapping DGs may overlap in a time domain.

In some implementations, in indicating the selected DG, process 600 may involve processor 412 transmitting to the network a signaling DG to indicate the selected DG. For instance, process 600 may involve processor 412 transmitting a MAC CE in the signaling DG to indicate the selected DG.

Alternatively, or additionally, in indicating the selected DG, process 600 may involve processor 412 transmitting to the network a SR in a SR occasion or using a PUCCH resource to indicate the selected DG.

Alternatively, or additionally, in indicating the selected DG, process 600 may involve processor 412 transmitting to the network an UCI signal in a PUCCH resource to indicate the selected DG.

Alternatively, or additionally, in indicating the selected DG, process 600 may involve processor 412 transmitting to the network a DMRS or an UCI signal with the selected DG to indicate the selected DG.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus implemented in a user equipment (UE), from a network a configuration of multiple overlapping configured grants (CGs);
selecting, by the processor, a CG from the multiple overlapping CGs to perform transmission in the selected CG; and
indicating, by the processor, the selected CG to the network.

2. The method of claim 1, wherein the multiple overlapping CGs overlap in a time domain.

3. The method of claim 1, wherein the indicating of the selected CG comprises transmitting to the network a signaling CG to indicate the selected CG.

4. The method of claim 3, wherein the indicating of the selected CG further comprises transmitting a medium access control (MAC) control element (CE) in the signaling CG to indicate the selected CG.

5. The method of claim 1, wherein the indicating of the selected CG comprises transmitting to the network a scheduling request (SR) in a SR occasion or using a physical uplink control channel (PUCCH) resource to indicate the selected CG.

6. The method of claim 1, wherein the indicating of the selected CG comprises transmitting to the network an uplink control information (UCI) signal in a physical uplink control channel (PUCCH) resource to indicate the selected CG.

7. The method of claim 1, wherein the indicating of the selected CG comprises transmitting to the network a demodulation reference signal (DMRS) or an uplink control information (UCI) signal with the selected CG to indicate the selected CG.

8. A method, comprising:
receiving, by a processor of an apparatus implemented in a user equipment (UE), from a network a configuration of multiple overlapping dynamic grants (DGs);
selecting, by the processor, a DG from the multiple overlapping DGs to perform transmission in the selected DG; and
indicating, by the processor, the selected DG to the network.

9. The method of claim 8, wherein the multiple overlapping DGs overlap in a time domain.

10. The method of claim 8, wherein the indicating of the selected DG comprises transmitting to the network a signaling DG to indicate the selected DG.

11. The method of claim 10, wherein the indicating of the selected DG further comprises transmitting a medium access control (MAC) control element (CE) in the signaling DG to indicate the selected DG.

12. The method of claim 8, wherein the indicating of the selected DG comprises transmitting to the network a scheduling request (SR) in a SR occasion or using a physical uplink control channel (PUCCH) resource to indicate the selected DG.

13. The method of claim 8, wherein the indicating of the selected DG comprises transmitting to the network an uplink control information (UCI) signal in a physical uplink control channel (PUCCH) resource to indicate the selected DG.

14. The method of claim 8, wherein the indicating of the selected DG comprises transmitting to the network a demodulation reference signal (DMRS) or an uplink control information (UCI) signal with the selected DG to indicate the selected DG.

15. An apparatus implementable in a user equipment (UE), comprising:
a transceiver configured to communicate wirelessly; and
a processor coupled to the transceiver and configured to perform, via the transceiver, operations comprising:
receiving, via the transceiver, from a network a configuration of multiple overlapping configured grants (CGs) or multiple overlapping dynamic grants (DGs);
selecting a CG or DG from the multiple overlapping CGs or DGs to perform transmission in the selected CG or DG; and
indicating, via the transceiver, the selected CG or DG to the network.

16. The apparatus of claim 15, wherein the multiple overlapping CGs or multiple overlapping DGs overlap in a time domain.

17. The apparatus of claim 15, wherein the indicating of the selected CG or DG comprises transmitting to the network a medium access control (MAC) control element (CE) in a signaling CG or DG to indicate the selected CG or DG.

18. The apparatus of claim 15, wherein the indicating of the selected CG or DG comprises transmitting to the network a scheduling request (SR) in a SR occasion or using a physical uplink control channel (PUCCH) resource to indicate the selected CG or DG.

19. The apparatus of claim 15, wherein the indicating of the selected CG or DG comprises transmitting to the network an uplink control information (UCI) signal in a physical uplink control channel (PUCCH) resource to indicate the selected CG or DG.

20. The apparatus of claim 15, wherein the indicating of the selected CG or DG comprises transmitting to the network a demodulation reference signal (DMRS) or an uplink control information (UCI) signal with the selected CG or DG to indicate the selected CG or DG.
